(19) United States
(12) Patent Application Publication
(10) Pub. No.: US 2018/0176503 A1
(43) Pub. Date: Jun. 21, 2018

(54) SIGNATURE GENERATION SYSTEM, SIGNATURE GENERATION APPARATUS, AND SIGNATURE GENERATION METHOD

(71) Applicant: Panasonic Intellectual Property Management Co., Ltd., Osaka (JP)

(72) Inventors: Katsunori KOGATA, Saitama (JP); Masakatsu MATSUO, Fukuoka (JP); Hiroyuki TANAKA, Fukuoka (JP); Kouji MUTOU, Fukuoka (JP); Hideo NOGUCHI, Fukuoka (JP); Satoshi ARITA, Fukuoka (JP)

(21) Appl. No.: 15/900,134

(22) Filed: Feb. 20, 2018

Related U.S. Application Data
(63) Continuation of application No. PCT/JP2016/000861, filed on Feb. 18, 2016.

(30) Foreign Application Priority Data
Aug. 21, 2015 (JP) 2015-163923

(51) Int. Cl. H04N 5/92; H04N 21/8352; H04N 21/4223; H04N 21/433; H04N 21/4408; H04N 21/4405; H04N 21/435; H04N 5/77; H04N 7/18

(52) U.S. Cl. CPC H04N 5/9201; H04N 21/8352; H04N 21/4223; H04N 21/4334; H04N 7/183; H04N 21/4405; H04N 21/435; H04N 5/77; H04N 21/4408

(57) ABSTRACT

A signature to be used to verify whether or not an original version video captured by a camera has been altered is assigned in the camera to improve the evidential quality of the original version video captured by the camera. The camera (2) includes: an image pickup unit that captures a video of an area to be monitored; a CPU that generates, using a portion or the entirety of video data of the area to be monitored captured by the image pickup unit, a signature for verifying whether or not the video data have been altered; and a network communication unit that sequentially transmits, to a client terminal (4), signed video data obtained by assigning the signature generated by the CPU to the video data. The client terminal (4) includes: a network communication unit that receives the signed video data that are sequentially transmitted from the network communication unit; a CPU that verifies whether or not the video data included in the signed video data received by the network communication unit have been altered; and a display (43) that outputs the result of the verification performed by the CPU.

### TECHNICAL FIELD

The present disclosure relates to a signature generation system in which a capturing device and a user terminal are connected to each other, a signature generation apparatus and a signature generation method used in the signature generation system.

### BACKGROUND ART

In the related art, there has been known a surveillance video recording system in which an installed capturing device assigns a signature (that is, an electronic signature) to video data obtained by capturing an area (for example, a crime scene or a place where some sort of incident has occurred) to be monitored and records video data, and thus it is possible to maintain the evidentiality of the video data.

For example, PTL 1 discloses a surveillance video recording device (for example, a recording device such as recorder and the like) that assigns a signature to a low-precision video (that is, an original video) and a high-precision video and records the images. According to PTL 1, since a surveillance video recording device, for example, obtains one super resolution image on the basis of a plurality of time series video, it is possible to maintain the evidentiality of the image even if a super resolution processing is performed on the low-precision video that is an original video.

### CITATION LIST

### Patent Literature

PTL 1: Japanese Patent Unexamined Publication No. 2010-219889

### SUMMARY OF THE INVENTION

The present disclosure provides a signature generation system, comprising: a capturing device and a user terminal which are connected to each other, wherein the capturing device includes a capture that captures a video of an area to be monitored, a signature generator that generates a signature for verifying a presence or absence of falsification of the video data using all or a part of video data of the area captured by the capture, and a transmitter that sequentially transmits, to the user terminal, signed video data obtained by assigning the signature generated by the signature generator to the video data, and the user terminal includes a first receiver that receives the signed video data sequentially transmitted from the transmitter, a verifier that verifies the presence or absence of falsification of video data contained in the signed video data received by the first receiver, and an output portion that outputs verification results obtained by the verifier.

The present disclosure provides a signature generation apparatus which is connected to a user terminal, comprising: a capture that captures a video of an area to be monitored, a signature generator that generates a signature for verifying a presence or absence of falsification of the video data using all or a part of video data of the area captured by the capture, and a transmitter that sequentially transmits, to the user terminal, signed video data obtained by assigning the signature generated by the signature generator to the video data.

The present disclosure provides a signature generation method for the signature generation apparatus which is connected to a user terminal and includes a capture, comprising: capturing a video of an area to be monitored using the capture, generating a signature for verifying a presence or absence of falsification of video data using all or a part of video data of the area captured by the capture, and sequentially transmitting, to the user terminal, signed video data obtained by assigning the generated signature to the video data.

According to the present disclosure, since a camera assigns a signature used for verifying whether or not data of an original video captured by the camera has been falsified at the time of transmitting data of the original video, it is possible to improve the evidentiality of the original video captured by the camera.

### BRIEF DESCRIPTION OF DRAWINGS

FIG. 1 is a block diagram illustrating a schematic configuration of a monitoring system of an exemplary embodiment.

FIG. 2 is a block diagram illustrating a schematic configuration of a camera in the monitoring system of the exemplary embodiment.

FIG. 3 is a diagram schematically illustrating the generation of signed video data in the camera of the monitoring system of the exemplary embodiment.

FIG. 4 is a block diagram illustrating a schematic configuration of a recorder in the monitoring system of the exemplary embodiment.

FIG. 5 is a block diagram illustrating a schematic configuration of a client terminal in the monitoring system of the exemplary embodiment.

FIG. 6 is a flowchart illustrating an overview of the operation of the camera in the monitoring system of the exemplary embodiment.

FIG. 7 is a flowchart illustrating an overview of the operation of the recorder in the monitoring system of the exemplary embodiment.

FIG. 8 is a flowchart illustrating an overview of the operation of the client terminal in the monitoring system of the exemplary embodiment.

### DESCRIPTION OF EMBODIMENT

Prior to the description of the exemplary embodiment, a problem in the related art will be simply described. In the technique disclosed in PTL 1 as described above, there has been a problem that, since the surveillance video recording device at the receiving side of the low-precision video generates a signature, it is impossible to maintain the evidentiality of the low-precision video in a case where the low-precision video has been falsified before the surveillance video recording device receives the low-precision video (that is, an original video) captured by a network camera at the transmitting side of the low-precision video.

In order to solve the problem in related art, an object of the present disclosure is to provide a signature generation system, a signature generation apparatus, and a signature generation method in which the camera assigns the signature used for verifying whether or not data of an original video captured by the camera has been falsified when the camera transmits the data of the original video, thereby improving the evidentiality of the original video captured by the camera.

Hereinafter, an exemplary embodiment (hereinafter, referred to as the exemplary embodiment) that specifically discloses the signature generation system, the signature generation apparatus and the signature generation method according to the present disclosure will be described in detail with reference to appropriate drawings. However, a more detailed description than necessary may be omitted. For example, there are cases where a detailed description of well-known matters and redundant description of substantially the same configuration may be omitted. This is for avoiding unnecessary redundancy of the following description and facilitating understanding by those skilled in the art. The accompanying drawings and the following description are provided to enable those skilled in the art to fully understand the present disclosure and are not intended to limit the claimed subject matters.

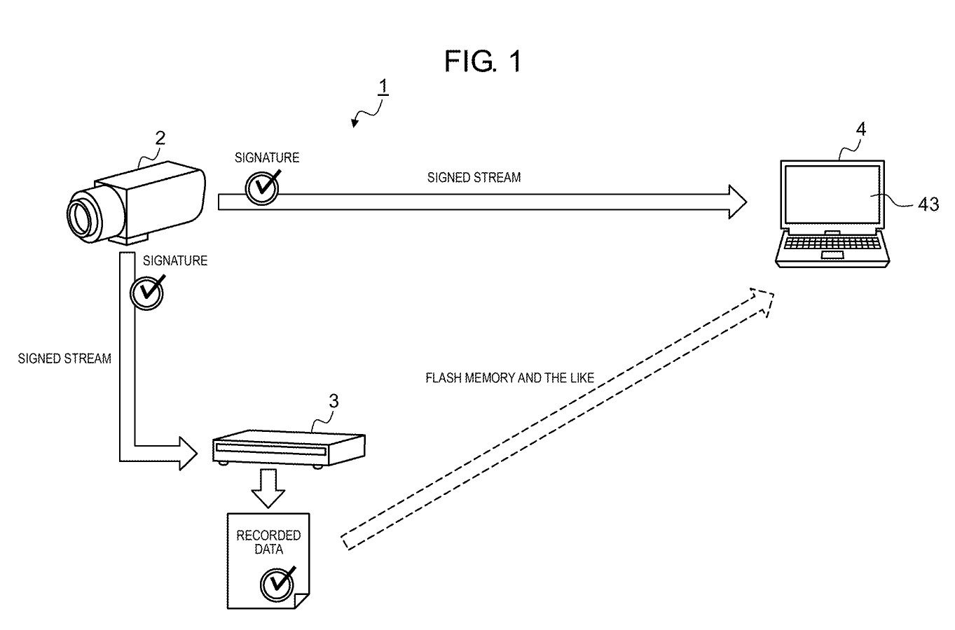

FIG. 1 is a block diagram illustrating a schematic configuration of monitoring system 1 of the exemplary embodiment. In the figure, monitoring system 1 of the exemplary embodiment includes camera 2, recorder 3, and client terminal 4. Monitoring system 1 of the exemplary embodiment, as a monitoring camera system, for example, can be used to monitor the status of the inside of a convenience store, or can be used to monitor the status of individual people, a vehicle or the like coming and going near an outdoor intersection.

For example, in a case where the camera is used to monitor the status of the inside of a convenience store, camera 2 is installed at a department inside the store (for example, a ceiling or corners in the store), and recorder 3 and client terminal 4 are installed in backyard of the head office of the convenience store or an office in the store and the like.

On the other hand, for example, in a case where the camera is used to monitor the status of individual people, a vehicle or the like coming and going near the intersection, camera 2 is installed at the intersection (for example, a telephone pole on which a traffic light is installed), and recorder 3 and client terminal 4 are installed in the police station that has jurisdiction over the location of the intersection.

Since camera 2 and recorder 3 are installed at positions separate from each other, and camera 2 and client terminal 4 are installed at positions separate from each other, the connections between camera 2 and recorder 3, and between camera 2 and client terminal 4, are established respectively via a network such as internet, intranet, and the like. The connections between camera 2 and recorder 3, and between camera 2 and client terminal 4 may be established via a wired connection, or a wireless connection.

In monitoring system 1 of the exemplary embodiment, a video data obtained by capturing using a stream format is sequentially transmitted from camera 2 to each of recorder 3 and client terminal 4. Recorder 3 receives video data sequentially transmitted from camera 2 in a stream format, and converts the video data in a stream format into a file and records the file. In a case where a display (not shown) is connected to recorder 3, a user (for example, a guard) operating recorder 3 reproduces video data recorded in recorder 3 and displays the video data on the display.

Client terminal 4 receives video data sequentially transmitted from camera 2 in real time, reproduces video data and displays the video data on display 43. Client terminal 4 may not only reproduce video data in real-time to display the video data on display 43, but may also read video data recorded in recorder 3 into a storage medium such as a flash memory and the like, and reproduces the read video data to display the video data on display 43. Client terminal 4 may obtain video data recorded in recorder 3 by downloading the video data via a network (not shown) from recorder 3.

A signature is assigned to video data sequentially transmitted from camera 2. In other words, camera 2 sequentially transmits video data with the signature in a stream format to recorder 3 and client terminal 4. Hereinafter, video data with the signature sequentially transmitted from camera 2 is simply called “signed video data” or “a signed stream”. Client terminal 4 verifies the presence or absence of falsification by a third party in communication paths of video data contained in the signed video stream. Hereinafter, each of camera 2, recorder 3 and client terminal 4 will be described in detail.

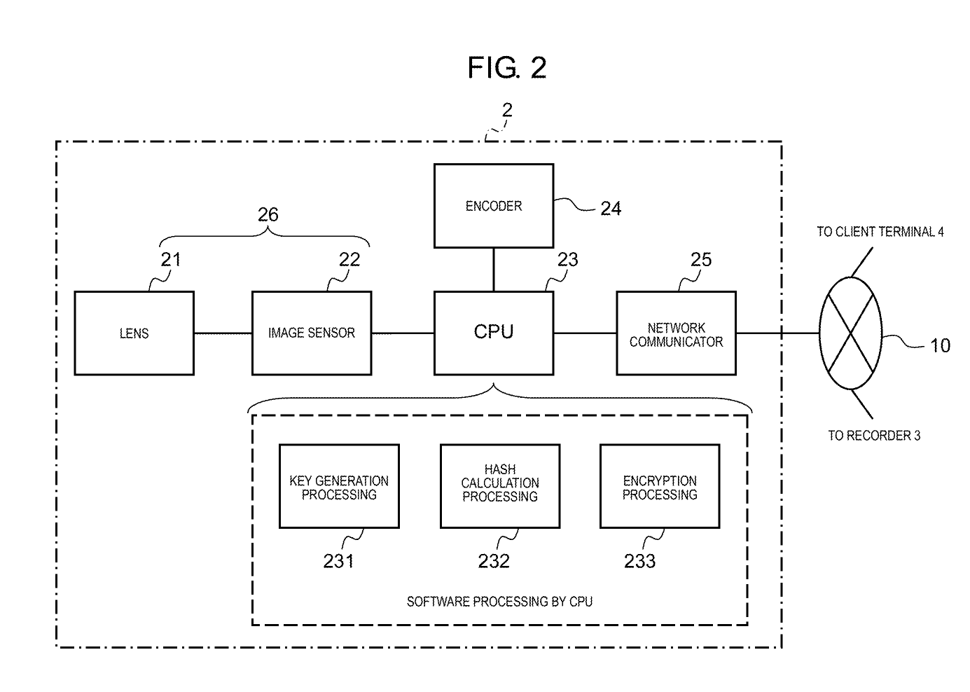

First, camera 2 will be described with reference to FIG. 2.

FIG. 2 is a block diagram illustrating a schematic configuration of camera 2 in monitoring system 1 of the exemplary embodiment. In the figure, camera 2 includes lens 21, image sensor 22, Central Processing Unit (CPU) 23, encoder 24 and network communicator 25. Camera 2 corresponds to a capturing device and a signature generation apparatus, and lens 21 and image sensor 22 constitute capture 26 of the capturing device and the signature generation apparatus. CPU 23 and encoder 24 constitute a signature generator. Network communicator 25 corresponds to a transmitter.

Lens 21 concentrates light reflected from a subject such as a person and the like coming and going in an area to be monitored, and forms an optical image of the concentrated light on the light receiving surface of image sensor 22. Image sensor 22, for example, is configured, using a Charge Coupled Device (CCD) type image sensor or a Complementary Metal Oxide Semiconductor (CMOS) type image sensor, to output electronic signals of the optical image formed on the light receiving surface by lens 21 (that is, electrical signals of an image constituting the video) to CPU 23.

CPU 23 performs a signal processing for an overall supervising operation control on respective portions of camera 2, a data input/output processing between other respective portions, a data calculation processing, and a data storage processing. Instead of CPU 23, a processor such as a Microprocessor (MPU) or a Digital Signal Processor (DSP) and the like may be used. For example, CPU 23 generates image data in a Red Green Blue (RGB) format or image data in a YUV (a luminance and a color difference) format perceivable by a person using the output of image sensor 22 (that is, electrical signals of an image).

Whenever the image data (that is, image data for one frame) is generated, CPU 23 passes the generated image data to encoder 24 and instructs encoder 24 to perform encoding on the image data. CPU 23 acquires the image data for one frame encoded by encoder 24 and temporarily stores the acquired image data in a cache (not shown) or a Random Access Memory (RAM) (not shown). CPU 23 may calculate a hash value (referred to as a digest value) according to a predetermined function (for example, a hash function already known) using all or a part of a bit string or binary data constituting image data for one frame, and encrypts calculated hash value to generate a signature. CPU 23 generates signed video data by assigning the generated signature to the image data for one frame stored temporarily. CPU 23 outputs the generated signed video data to network communicator 25 and sequentially transmits the signed video data from network communicator 25 to recorder 3 and client terminal 4.

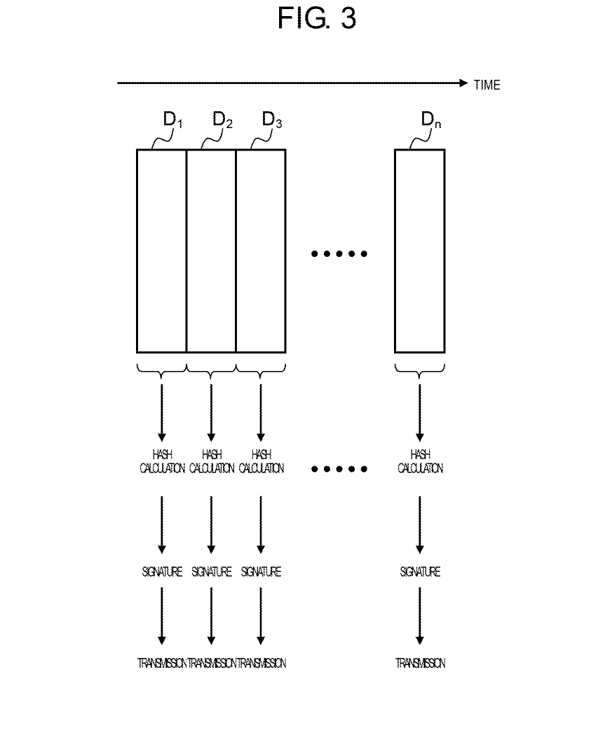

FIG. 3 is a diagram schematically illustrating the generation of the signed video data in camera 2 of monitoring system 1 of the exemplary embodiment. As described above, the signed video data in a stream format from camera 2 is sequentially transmitted to recorder 3 and client terminal 4. As shown in the figure, CPU 23 performs the calculation for obtaining a hash value with respect to image data Di (i=1, 2, 3, . . . , n) for each one frame, and executes the encryption of the hash value obtained by the calculation of the hash value so that the signature is generated. Furthermore, CPU 23 transmits the signed video data in which the generated signature is assigned to image data Di.

Returning to FIG. 2, CPU 23 generates a pair of a public key and a private key in advance (that is, before performing the transmission of the signed video data). CPU 23 may store and maintain the data of the public key in a certificate issued, for example, from a certificate authority station (a Certificated Authority (CA) station) using the data of the private key at the time of the encryption processing of the hash value, and may maintain the data of the public key alone, independently of the certificate. For example, in the exemplary embodiment, the data of the public key of camera 2 is delivered from camera 2 to client terminal 4, in a state of being contained in the certificate. As a method of delivering the certificate, in the exemplary embodiment, a method of downloading the certificate from camera 2 to client terminal 4 is adopted. As another method of delivering the certificate, there is a method of attaching the certificate acquired by camera 2 and transmitting the certificate, or a method of transmitting the certificate in a stream format together with signed video data. It is also possible to send only the public key individually rather than send the public key in a state of being included in the certificate. In a case where camera 2 updates the public key in relation to a valid period, camera 2 may send the public key in an appropriate case using any one of above methods after updating the public key.

As shown in FIG. 2, each of key generation processing 231, hash calculation processing 232, and encryption processing 233 is executed as a software processing by CPU 23. In key generation processing 231, CPU 23 generates, for example, both data of the public key and data of the private key of camera 2. In hash calculation processing 232, CPU 23 calculates the hash value using all or a part of image data Di. In encryption processing 233, CPU 23 encrypts the hash value to generate the signature which is assigned to image data Di.

Whenever CPU 23 assigns image data Di for one frame to encoder 24, the encoder encodes image data Di to be suitable for a predetermined transmission format and returns the encoded image data to CPU 23.

Network communicator 25 communicates with recorder 3 and client terminal 4 respectively, via the internet (or an intranet) 10. Network communicator 25 as an example of a transmitter sequentially transmits signed video data in a stream format generated by CPU 23 to recorder 3 and client terminal 4 via the internet (or an intranet) 10. For example, in a case where a download request of the public key of camera 2 is made from client terminal 4, network communicator 25 transmits the data of the public key generated by CPU 23 via the internet (or an intranet) 10 to client terminal 4.

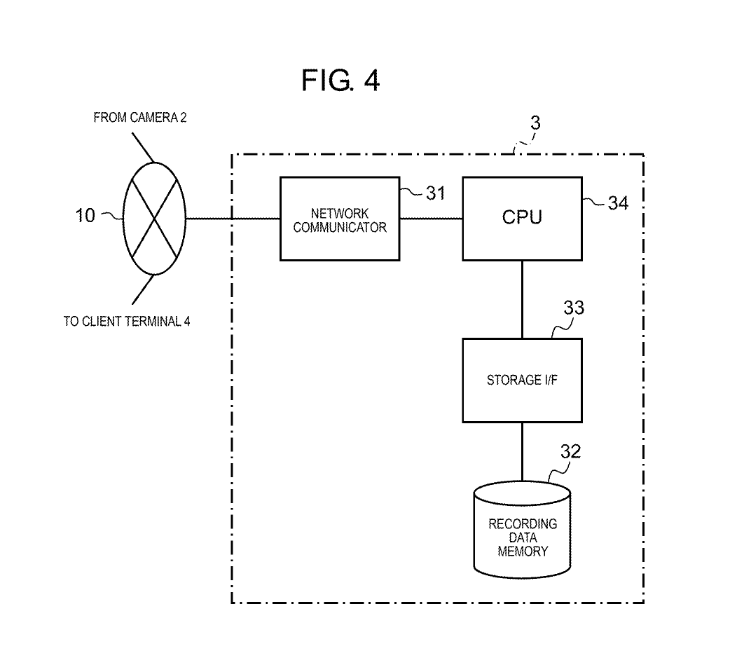

Next, recorder 3 will be described with reference to FIG. 4.

FIG. 4 is a block diagram illustrating a schematic configuration of recorder 3 in monitoring system 1 of the exemplary embodiment. In the figure, recorder 3 includes network communicator 31, recording data memory 32, storage I/F 33, and CPU 34. Network communicator 31 corresponds to a second receiver. Recording data memory 32 corresponds to a recording portion.

Network communicator 31 communicates with camera 2 and client terminal 4 respectively, via the internet (or an intranet) 10. Recording data memory 32 is configured, for example, using a flash memory or a hard disk, and records video data. Storage I/F 33 is connected to each other between recording data memory 32 and CPU 34.

CPU 34 performs a signal processing for an overall supervising operation control on respective portions of recorder 3, a data input/output processing between other respective portions, a data calculation processing, and a data storage processing. Instead of CPU 34, a processor such as an MPU, a DSP or the like may be used. For example, CPU 34 converts signed video data in a stream format from camera 2 into a file, the signed video data being received by network communicator 31, and records the file in recording data memory 32, the file being indexed by a file name and a time (for example, a file-converted time and a recording time). Since the signed video data in a stream format is sequentially transmitted from camera 2 to recorder 3, CPU 34 converts the signed video data into the file at the time when a predetermined amount of image data Di contained in the signed video data is accumulated. For example, CPU 34 converts the signed video data of the number of frames in 10 minutes into a file as one unit.

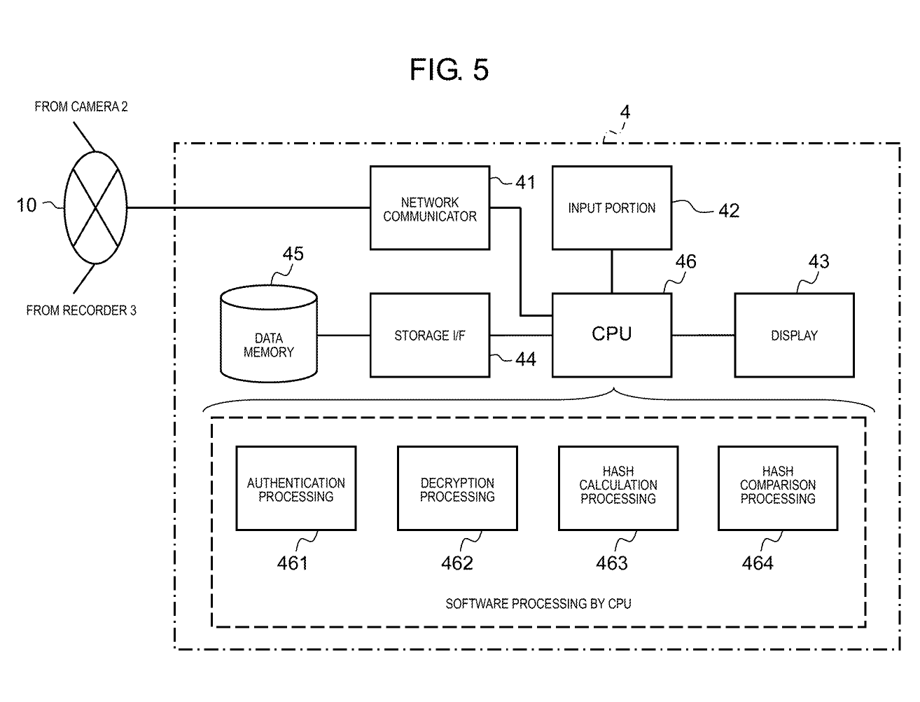

Next, client terminal 4 will be described with reference to FIG. 5.

FIG. 5 is a block diagram illustrating a schematic configuration of client terminal 4 in monitoring system 1 of the exemplary embodiment. In the figure, client terminal 4 includes network communicator 41, input portion 42, display 43, storage I/F 44, data memory 45 and CPU 46. Client terminal 4 corresponds to a user terminal. Network communicator 41 corresponds to a first receiver. CPU 46 corresponds to a verifier. Display 43 and CPU 46 constitute an output portion.

Network communicator 41 communicates with camera 2 and recorder 3 respectively, via the internet (or an intranet) 10. Input portion 42 is configured, using an input device such as a mouse, a keyboard and the like operable by the user who operates client terminal 4, to receive the input of various commands for inputting characters or controlling CPU 46.

Display 43 displays an operation screen for operating client terminal 4, and projects video data of the area to be monitored that has been captured by camera 2. Storage I/F 44 is connected to each other between data memory 45 and CPU 46. Data memory 45 is configured, for example, using a flash memory or a hard disk, to store the signed video data or data of the certificate including the public key of camera 2.

CPU 46 acquires, from network communicator 41, data of the certificate including data of the public key of camera 2, which has been downloaded from camera 2 by network communicator 41, and authenticates the normality of data of the public key of camera 2 contained in the certificate. Since an authentication method for the normality of data of the public key of camera 2 contained in data of the certificate is practicable using a well-known technology, the descriptions thereof are omitted in the exemplary embodiment. In a case where data of the public key of the camera 2 has been authenticated as data of a normal public key, CPU 46 stores data of the public key of camera 2 in data memory 45. In a case where the signed video data from camera 2 has been transmitted, CPU 46 verifies the presence or absence of falsification for each one frame of image data Di constituting the video data. In a case where it is determined that video data is not falsified on the basis of the verification results for falsification of video data, CPU 46 reproduces video data and displays the video on display 43. On the other hand, in a case where it is determined that video data is falsified, CPU 46 stops reproducing video data at the time of the determination, and thus does not display the video data on display 43. Therefore, for example, even if video data contained in the signed video data in communication paths from camera 2 to client terminal 4 has been falsified, a user (for example, a guard) operating client terminal 4 may appropriately eliminate the influence of a third party that has performed the falsification of the signed video data, because the falsified video data does not be reproduced in client terminal 4 and thus a false video data cannot be browsed through.

In a case where a recorded data (that is, a file-converted signed video data) from recording data memory 32 of recorder 3 is read, CPU 46 verifies, for the recorded data, the presence or absence of falsification for each one frame of image data Di constituting the video data in the same way as the above. In a case where it is determined that video data is not falsified on the basis of the verification results for falsification of video data, CPU 46 reproduces the video data and displays the video on display 43. On the other hand, in a case where it is determined that the video data has been falsified, CPU 46 stops reproducing the video data at the time of determination, and thus does not display the video data on display 43. Client terminal 4 may store the recorded data read from recording data memory 32 of recorder 3 in data memory 45, but, in a case where video data is falsified, storing the recorded data in data memory 45 may be omitted.

CPU 46 decrypts the signature of the acquired signed video data using the public key stored in data memory 45. CPU 46 calculates, for video data itself, a hash value using image data Di constituting video data. In camera 2 and client terminal 4, the same hash function is used to calculate the hash value. CPU 46 compares a hash value obtained by decrypting the signature with a hash value obtained by the hash calculation of image data Di to which the signature is assigned. In a case where it is determined that the hash values match each other, CPU 46 determines that video data is not falsified, reproduces video data, and outputs the reproduced video data to display 43 to be displayed. On the other hand, in a case where it is determined that the hash values do not match each other, CPU 46 determines that video data is falsified, and neither reproduces the video data nor outputs the video data to display 43.

CPU 46 may include the verification results of the presence or absence of falsification of video data in video data, or make display 43 display the verification results. In a case where CPU 46 makes display 43 display the verification results, for example, CPU 46 displays a message that “falsification occurs”, if video data is falsified, or displays another message that “falsification does not occur”, if video data is not falsified.

Accordingly, according to monitoring system 1 of the exemplary embodiment, before the client terminal 4 itself receives the signed video data transmitted from camera 2, client terminal 4 may correctly check the presence or absence of falsification without missing the slightest falsification of the signed video data, by verifying the presence or absence of falsification for each one frame of image data Di constituting video data, and thus improve the evidentiality of video data. Further, according to monitoring system 1, since camera 2 may assign a signature used for verifying whether or not video data as original video data captured by the camera 2 itself is falsified when camera 2 transmits the video data, a post-stage apparatus (for example, client terminal 4) connected to camera 2 verifies the signature, and thus may improve the evidentiality of video data captured by camera 2.

As shown in FIG. 5, each of authentication processing 461, decryption processing 462, hash calculation processing 463 and hash comparison processing 464 is executed as a software processing by CPU 46. In authentication processing 461, CPU 46 performs, for example, an authentication for the normality of data of the public key of camera 2. In decryption processing 462, CPU 46 decrypts the signature contained in the signed video data. In hash calculation processing 463, CPU 46 calculates a hash value using video data contained in the signed video data. In hash comparison processing 464, CPU 46 compares a hash value obtained by decrypting the signature in decryption processing 462 with a hash value obtained by hash-calculation using video data in hash calculation processing 463.

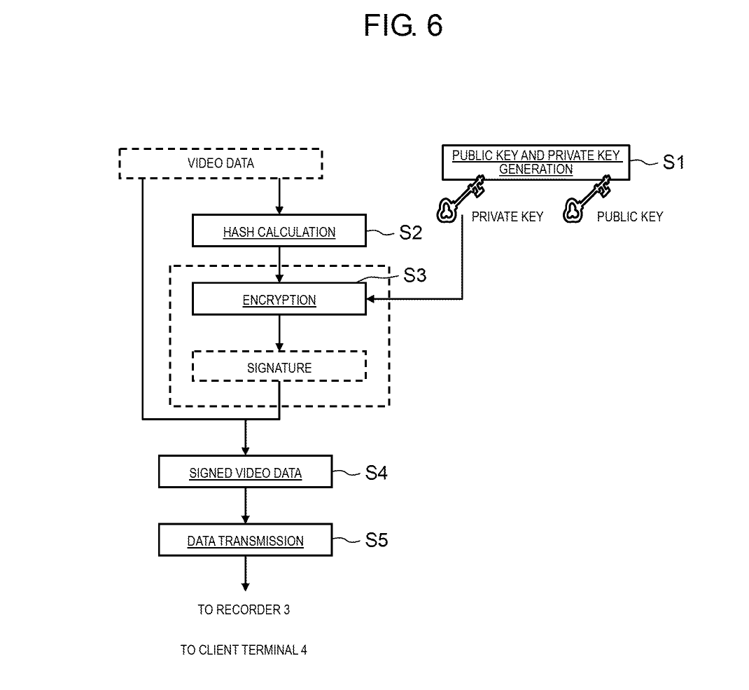

Next, the overview of each operation of camera 2, recorder 3 and client terminal 4 will be described with reference to FIGS. 6 to 8.

FIG. 6 is a flowchart illustrating an overview of the operation of camera 2 in monitoring system 1 of the exemplary embodiment. In the figure, CPU 23 generates a pair of data of a public key and data of a private key, stores the private key to be used for encryption processing on the hash value of the private key, and stores the public key to be downloadable by client terminal 4 (51).

After CPU 23 generates a pair of data of the public key and data of the private key, CPU 23 captures image signals output from image sensor 22, and generates image data D₁ for one frame in an RGB format or a YUV format perceivable by a person. After CPU 23 generates image data D₁ for one frame, CPU 23 outputs the generated image data D₁ for one frame to encoder 24 and instructs encoder 24 to perform encoding on the image data for one frame. In a case where, after CPU 23 instructs encoder 24 to perform encoding on image data D₁ for one frame, CPU 23 acquires image data D₁ for one frame encoded by encoder 24, CPU 23 temporarily stores the acquired encoded image data D₁ in a cache (not shown) or a RAM (not shown).

Further, CPU 23 calculates a hash value according to a hash function already known using all or a part of a bit string or binary data constituting image data D₁ for one frame encoded by encoder 24 (S2), and encrypts the hash value with data of the private key and generates the signature (S3).

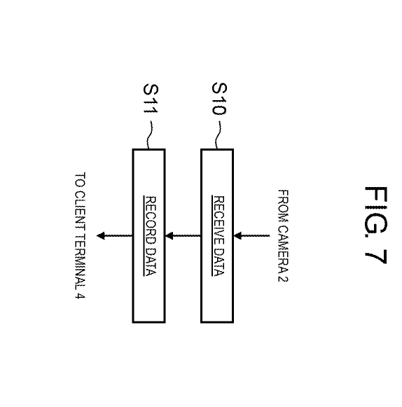

After CPU 23 generates the signature, CPU 23 generates the signed video data by assigning the signature to image data D₁ for one frame stored temporarily (S4). CPU 23 outputs the generated signed video data to network communicator 25, and transmits the signed video data from network communicator 25 to recorder 3 and client terminal 4 (S5). CPU 23 repeatedly performs a processing in steps S2 to S5 on image data D₂, D₃, . . . , Dₙ subsequent to image data D₁ for the first frame. FIG. 7 is a flowchart illustrating an overview of the operation of recorder 3 in monitoring system 1 of the exemplary embodiment.

In the figure, in a case where network communicator 31 receives the signed video data in a stream format sequentially transmitted from camera 2 (S10), CPU 34 converts the signed video data in a stream format from camera 2 into a file, and records the file in recording data memory 32, the file being indexed by a file name and a time (for example, a file-converted time and a recording time) (S11). Therefore, in a case where, for example, a read request of signed video data on a date desired by the user is received from client terminal 4 to recorder 3, recorder 3 acquires signed video data on the corresponding date and transmits the acquired signed video data to client terminal 4. In other words, in addition to the signed video data that is sequentially transmitted from camera 2 in real time, client terminal 4 may acquire the signed video data on a certain date desired by a user (for example, a guard) from recorder 3. In a case where the verification of the signature succeeds, client terminal 4 may reproduce video data contained in the acquired video data.

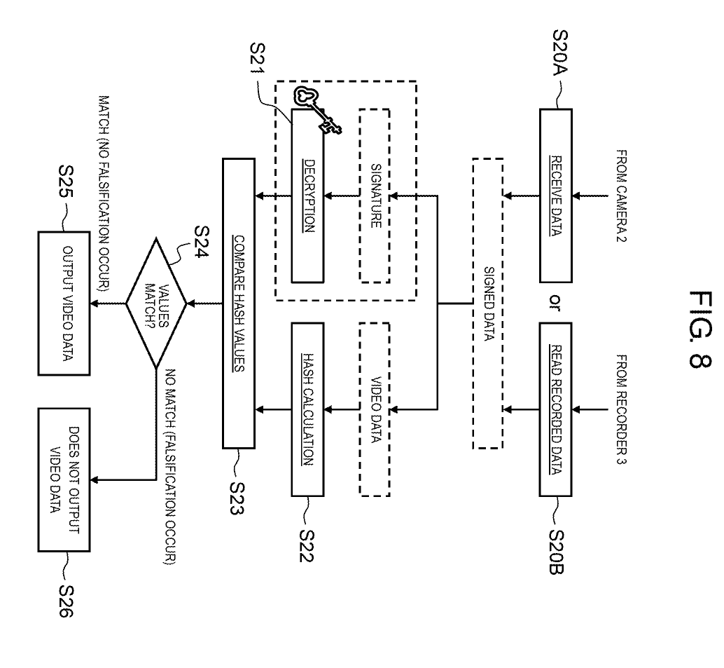

FIG. 8 is a flowchart illustrating an overview of the operation of client terminal 4 in monitoring system 1 of the exemplary embodiment. On a premise of the description of FIG. 8, CPU 46 acquires data of a certificate, including data of the public key of camera 2 from network communicator 41, which has been downloaded from camera 2 by network communicator 41, and authenticates that the acquired data of the public key of camera 2 is data of a normal public key. As a result, CPU 46 stores data of the public key of camera 2 in data memory 45.

In FIG. 8, in a case where network communicator 41 receives the signed video data transmitted from camera 2 (S20A), CPU 46 separates a signature and video data in the received signed video data. CPU 46 decrypts the signature using data of the public key stored in data memory 45 with respect to the signature separated from the signed video data, and obtains a hash value (S21).

In the other hand, CPU 46 calculates a hash value using all or a part of a bit string or binary data constituting image data D₁ for the first frame of image data Di constituting video data with respect to video data separated from the signed video data, and obtains a hash value (S22). In a case where CPU 46 obtains a hash value decrypted from the signature and a hash value calculated for one frame of image data D₁ constituting video data, CPU 46 compares both hash values (S23), and determines whether or not both hash values match each other (S24).

In a case where CPU 46 determines that both hash values match each other (in other words, video data is not falsified), CPU 46 reproduces video data and outputs the video data to display 43 (S25).

On the other hand, in a case where CPU 46 determines that both hash values do not match each other (in other words, video data is falsified), CPU 46 does not output the video data (S26). CPU 46 repeatedly performs a processing in steps S21 to S26 on image data D₂, D₃, . . . , Dₙ subsequent to image data D₁ for the first frame.

On the other hand, in a case where CPU 46 reads a recorded data from recording data memory 32 of recorder 3 (S20B), CPU 46 performs a processing similar to a case where network communicator 41 receives the signed video data transmitted from camera 2 (that is, each processing from step S21 to step S26).

As describe above, in monitoring system 1 of the exemplary embodiment, camera 2 captures a video of an area to be monitored, generates a signature for verifying the presence or absence of falsification of video data using all or a part of video data of the captured area to be monitored, and sequentially transmits, to client terminal 4, signed video data to which the generated signature is assigned. Client terminal 4 receives signed video data sequentially transmitted from camera 2, verifies the presence or absence of falsification of video data contained in the received signed video data, and outputs verification results.

Therefore, according to monitoring system 1, camera 2 at a transmitting side of a signature may assign a signature used for verifying whether or not video data as original video data captured by camera 2 itself has been falsified at the time of sequentially transmitting the video data, which is a signed video data. In a case where the verification for the signature assigned by camera 2 succeeds, an apparatus at the receiving side of the signature (for example, client terminal 4) may guarantee that video data is not falsified in communication paths from camera 2 to the apparatus at the receiving side of the signature (specifically, communication paths from camera 2 to client terminal 4), and thus it is possible to improve the evidence establishability of video data as original video data captured by camera 2.

Further, according to monitoring system 1 of the exemplary embodiment, recorder 3 receives the signed video data sequentially transmitted from camera 2, and records the received signed video data. Client terminal 4 verifies the presence or absence of falsification of video data contained in the signed video data using the signed video data read from recorder 3. Therefore, in a case where the signature verification in client terminal 4 succeeds, monitoring system 1 can guarantee that falsification does not occur in a communication path from camera 2 to recorder 3 as well as a communication path from recorder 3 to client terminal 4, and thus improve the evidence establishability of video being captured by camera 2 and recorded by recorder 3.

Further, according to monitoring system 1 of the exemplary embodiment, camera 2 generates a signature for each one frame of an image constituting the captured video data. Therefore, monitoring system 1 may verify whether the falsification occurs for each one frame of the image constituting the video data, and thus improve the evidence establishability of the video data as the original video data captured by camera 2. Further, according to monitoring system 1 of the exemplary embodiment, it is possible to generate a signature for a predetermined number of frames to be accumulated, without being limited to generating a signature for each one frame. Therefore, it is difficult for client terminal 4 to verify whether falsification occurs for any one frame among a predetermined number of frames, but it is possible to eliminate a signature generation processing load from camera 2.

Further, according to monitoring system 1 of the exemplary embodiment, in a case where client terminal 4 determines that video data contained in the signed video data is not falsified, client terminal 4 reproduces and outputs the video data. Therefore, there is no possibility that a user (for example, a guard) operating client terminal 4 falsely recognize the video by watching a video subjected to falsification.

### INDUSTRIAL APPLICABILITY

The present disclosure has effects that it is possible to improve the evidentiality of the original video captured by a camera because a camera assigns a signature used for verifying whether or not data of the original video captured by the camera has been falsified at the time of transmitting data of the original video, and is applicable to a monitoring camera system that performs monitoring of, for example, the inside of the convenience store or monitoring intersection.

### REFERENCE MARKS IN THE DRAWINGS

1 MONITORING SYSTEM
2 CAMERA
3 RECORDER
4 CLIENT TERMINAL
10 INTERNET
21 LENS
22 IMAGE SENSOR
23, 34, 46 CPU
24 ENCODER
25, 31 NETWORK COMMUNICATOR
26 CAPTURE
33, 44 STORAGE I/F
32 RECORDING DATA MEMORY
42 INPUT PORTION
43 DISPLAY
45 DATA MEMORY
231 KEY GENERATION PROCESSING
232 HASH CALCULATION PROCESSING
233 ENCRYPTION PROCESSING
461 AUTHENTICATION PROCESSING
462 DECRYPTION PROCESSING
463 HASH CALCULATION PROCESSING
464 HASH COMPARISON PROCESSING

1. A signature generation system, comprising:
a capturing device and a user terminal which are connected to each other,
wherein the capturing device includes
a capture that captures a video of an area to be monitored,
a signature generator that generates a signature for verifying whether or not the video data has been falsified using all or a part of video data of the area captured by the capture, and
a transmitter that sequentially transmits, to the user terminal, signed video data obtained by assigning the signature generated by the signature generator to the video data, and
the user terminal includes
a first receiver that receives the signed video data sequentially transmitted from the transmitter,
a verifier that verifies the presence or absence of falsification of video data contained in the signed video data received by the first receiver, and
an output portion that outputs verification results by the verifier.

2. The signature generation system of claim 1, further comprising:
a recorder which includes
a second receiver that receives the signed video data sequentially transmitted from the transmitter, and
a recording portion that records the signed video data received by the second receiver,
wherein the verifier verifies the presence or absence of falsification of video data contained in the signed video data using the signed video data read from the recorder.

3. The signature generation system of claim 1,
wherein the signature generator generates the signature for each one frame of an image constituting the video data obtained by the capture.

4. The signature generation system of claim 3,
wherein the transmitter transmits the signed video data to the user terminal in a stream format.

5. The signature generation system of claim 3,
wherein the signature generator encrypts a hash value obtained using image data for each one frame of an image constituting the video data captured by the capture and generates the signature.

6. The signature generation system of claim 5,
wherein the verifier verifies the presence or absence of falsification of video data obtained by comparing a hash value obtained by decrypting a signature that is assigned to the signed video data received by a first receiver with a hash value obtained by image data for each one frame of an image constituting video data of the signed video data.

7. The signature generation system of claim 3,
wherein, in a case where the verifier determines that video data contained in the signed video data does not be falsified, the output portion outputs the video data.

8. The signature generation system of claim 3,
wherein, in a case where the verifier determines that video data contained in the signed video data is falsified, the output portion does not output the video data.

9. The signature generation system of claim 3,
wherein, in a case where the verifier determines that video data contained in the signed video data is falsified, the output portion outputs the fact that the video data is falsified.

10. The signature generation system of claim 2,
wherein the signature generator generates the signature for each one frame of an image constituting the video data obtained by the capture.

11. The signature generation system of claim 2,
wherein, in a case where the verifier determines that video data contained in the signed video data does not be falsified, the output portion outputs the video data.

12. A signature generation apparatus which is connected to a user terminal, comprising:
a capture that captures a video of an area to be monitored;
a signature generator that generates a signature for verifying a presence or absence of falsification of the video data using all or a part of video data of the area captured by the capture; and
a transmitter that sequentially transmits, to the user terminal, signed video data obtained by assigning the signature generated by the signature generator to the video data.

13. A signature generation method in a signature generation apparatus which is connected to a user terminal and includes a capture, comprising:
capturing a video of an area to be monitored using the capture;
generating a signature for verifying a presence or absence of falsification of video data using all or a part of the video data of the area captured by the capture; and
sequentially transmitting, to the user terminal, signed video data obtained by assigning the generated signature to the video data.
